(19) United States
(12) Patent Application Publication
(10) Pub. No.: US 2016/0342663 A1
(43) Pub. Date: Nov. 24, 2016

(54) DIRECTING CONTENT TO USERS OF A COMPUTER SYSTEM BASED ON PREVIOUSLY ACCESSSED CONTENT

(71) Applicant: Boston Logic Technology Partners, Inc., Boston, MA (US)

(72) Inventors: David G. Friedman, Boston, MA (US); Thomas M. Cocca, Boston, MA (US)

(21) Appl. No.: 15/159,570

(22) Filed: May 19, 2016

Related U.S. Application Data
(60) Provisional application No. 62/165,233, filed on May 22, 2015.

(51) Int. Cl. G06F 17/30; H04L 29/06; G06Q 50/16; H04L 29/08

(52) U.S. Cl. CPC G06F 17/30554; H04L 67/02; H04L 67/42; H04L 67/1097; G06F 17/30477; G06F 17/30864; G06Q 50/16

(57) ABSTRACT

A website is configured to store a hierarchy of information on a client computer, depending on how much of the website has been navigated by the user. Information indicating content viewed, searches performed on a database, and records viewed in response to a search, can be stored. After a user has viewed content on a first website, and data about the viewed content is stored on a client computer, recommended content related to the viewed content can be served when the user accesses another appropriately configured second website from that client computer. The recommended content can include an image from the originally viewed content, and dynamic content derived from metadata associated with the viewed content, or other content depending on the data stored on the client computer. If the user selects the recommended content, data can be accessed from the first website, such as a database query.

### CROSS-REFERENCE TO RELATED APPLICATIONS

This application is a non-provisional application of U.S. Provisional Patent Application Ser. No. 62/165,233, filed May 22, 2015, which is hereby incorporated by reference.

### BACKGROUND

On the internet, websites are defined by resources accessible from server computers. Client computers request access to such resources using a resource identifier, such as a uniform resource locator (URL) or uniform resource identifier (URI), and such requests are routed to the server computers over the internet by components of a computer network based in part on the resource identifier. The server computer hosting the resource responds by sending the requested resource over the internet to the client computer. A website typically is defined by a combination of computer programs and data that, when processed by the client computer, present the website on a display or other output devices of the client computer. In some cases, the website causes the client computer to store data about the access of the website. Such data often is called a “cookie”.

A website often includes additional recommended content for a user. To generate such recommended content, the website may include computer program code that causes the client computer to send a request to another server for the recommended content. The request can include one or more cookies stored on the client computer, or contents of those cookies may have been previously transmitted to the other server. The other server responds to the request with data defining the recommended content for that user. This recommended content is processed by the client computer, as instructed by the computer program code and data for the website, to present the recommended content as part of the website.

As an example, there may be a website providing a search service and an advertisement server providing an advertisement service. The searching website can cause cookies to be stored on client computers, which cookies include search parameters used for searching. Other websites from other companies can have advertisements, generated by the advertisement service, by including computer program code accesses the advertisement service. The computer program code for the first website may include code associated with the advertisement service to generate cookies in a form designed for the advertising service. The computer program code for these other websites can cause the client computer to access the cookies for the search service stored on the client computer and to submit the cookies to the advertisement service, which generates and provides advertising content.

### SUMMARY

This Summary introduces selected concepts in simplified form which are described further below in the Detailed Description. This Summary is intended neither to identify essential features, nor to limit the scope, of the claimed subject matter.

A computer system generates and transmits recommended content to a client computer such that the recommended content is progressively more specific in relation to how progressively more engaged a user has been with a website. For example, the recommended content for a user who has accessed a specific record from a database on a website can be more specific than the recommended content for a user who has accessed only a “home” page or other higher level page on that website. To provide such an implementation, additional data stored for a website on the client computer, e.g., the one or more “cookies”, are progressively more detailed as the user is more engaged with the website, and the corresponding recommended content is progressively more specific.

For example, a website can be configured to define and store a hierarchy of additional data, e.g., in one or more cookies, to reflect how much of the website has been navigated by a user. For example, the additional data can include information about specific “pages” or other resources from the website that have been accessed by a user. The additional data can include, for example, a specific page that has been accessed, parameters of searches performed on a database accessible through the website, and particular records from the database that were accessed from search results, and/or metadata about such records.

After a user has accessed content on a first website through a client computer, and the additional data about the accessed content is stored on the client computer, recommended content related to the accessed content can be served when the user accesses another appropriately configured second website using that client computer. The recommended content can include, for example, an image related to the originally accessed content, or dynamic content derived from metadata associated with the accessed content, or other content depending on the data stored on the client computer. The metadata can be used, for example, to construct a search query to a database on the first website. If the user selects the recommended content from the second website, a search can be performed on the database on the first website which in turn returns results from that database.

The originally accessed content from a first website can be, for example, search results from a real estate database, a particular real estate offering from the real estate database, a particular real estate offering from a particular broker (which may be called an “exclusive” listing), or yet other content from a real estate broker website such as a home page, a broker page, or a location or city page providing information about properties in a specific location. The recommended content placed in the second website can be, for example, an offer to redirect the user to access the first website, such as to direct the user to the originally accessed content from the first website, or perform a search for real estate from that real estate database. The recommended content in such an instance can include a link to the resource to be accessed on the first website, and an image of a particular real estate offering that was previously view or other generic image of real estate such as a stock photo, and can include dynamically generated text indicating the parameters of a search to be performed. The parameters of the search can be extracted from metadata associated with the particular real estate offering which was previously viewed, which may be stored in a cookie. For example, if the previously viewed offering was a three-bedroom, single-family home in a particular city or region, then the search can be for three-bedroom, single-family homes in the same city or region.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### BRIEF DESCRIPTION OF THE DRAWINGS

FIG. 1 is a block diagram of an example system of providing content on a computer network.

FIG. 2 is a data flow diagram of an example implementation of such a system.

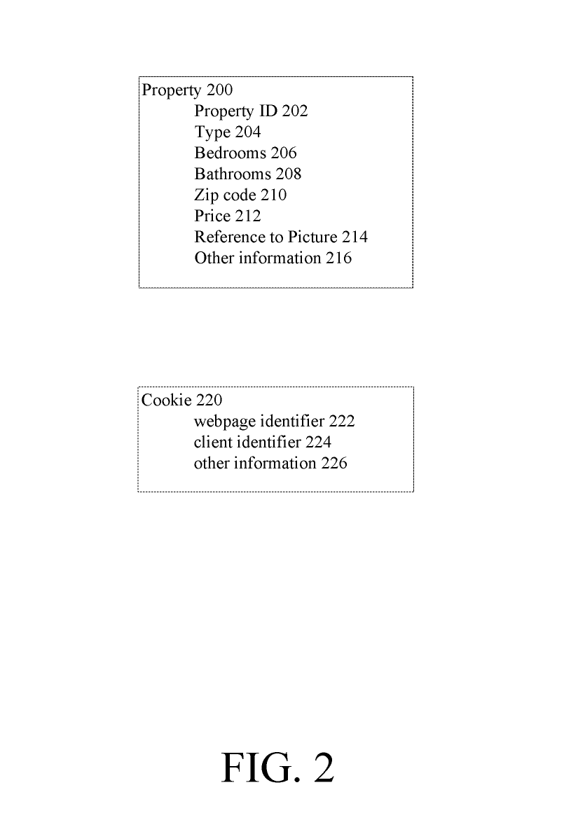

FIG. 3 is a flow chart of an example implementation.

FIG. 4 is a flow chart of an example implementation.

FIG. 5 is a flow chart of an example implementation.

FIG. 6 is a flow chart of an example implementation.

FIG. 7 is an illustration of relationships between cookie data and recommended content in one example implementation.

FIG. 8 is an illustration of relationships between cookie data and recommended content in another example implementation.

FIG. 9 is a block diagram of an example computer system.

### DETAILED DESCRIPTION

The following section provides an example operating environment of a computer system that provides recommended content to users.

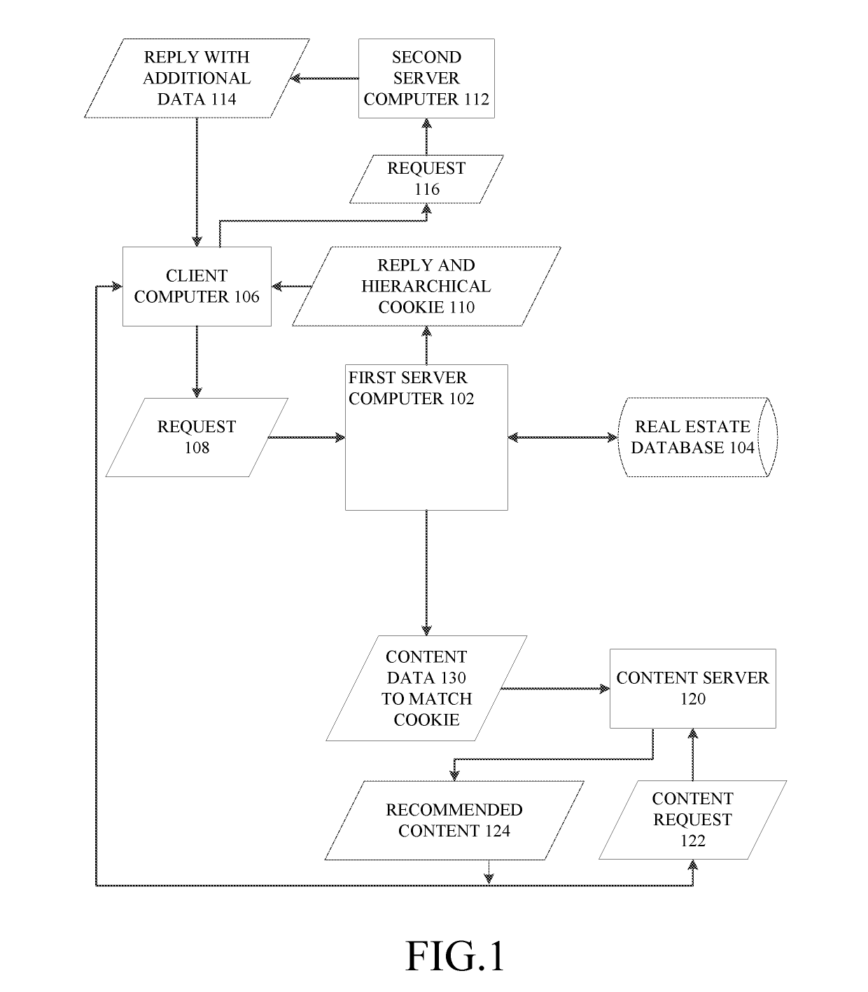

Referring to FIG. 1, a computer system 100 includes a first server computer 102 that provides content for a first website. In this example, the first server computer accesses a real estate database 104 that includes information about real estate properties available for sale. Content from the first website is provided by the first server computer 102 to a user of a client computer 106 over a computer network, such as the Internet, in response to requests 108 submitted to the server computer. Such content is shown in FIG. 1 as a reply and “cookie” 110. A “cookie” is a common term for additional data stored by a server computer, e.g., 102, on a client computer about the client computer's access of the website served by the server computer. A request 108 from a client computer typically includes a reference to the server computer using a “domain name” for the server computer and optionally a file name, path name or other resource name for a resource available from the server computer. The data identifying a resource available from a server computer is commonly called a “link” or “hyperlink” or uniform resource identifier or locator (URL or URI).

The first website can include a number of different pieces of content, commonly called pages, such as a “home page”, which is the common name for a first page accessed when the client computer requests a webpage from a server computer using its domain name. Other resources might be provided by or accessible from the server computer if the client computer provides a file name, path name or other resource name for the resource. Other “pages” may be accessed to provide additional content to the client computer. One or more pages may provide a search interface through which the client computer can enter parameters to search the database 104. Yet other pages may provide results from such database searches, and provide links to access specific records from the database that are identified in the results. Yet other pages may provide data for a specific record from the database.

For example, in real estate, the information that may be used to search the database, or that may be returned from a specific record from the database, can include information such as a specific property identifier, or a keyword or text description of a property, a geographic areas, such as a city or county or neighborhood, a property type, a price or price range, or other characteristics of a property such as a number of bedrooms, room, bathrooms, floors, units, acres of land, etc. A website for a real estate broker may include a variety of pages, such as, but not limited to, search results from a real estate database, a particular real estate offering from the real estate database, a particular real estate offering from a particular broker (which may be called an “exclusive” listing), or yet other content from a real estate broker website such as a home page, a broker page, or a location or city page providing information about properties in a specific location.

As described in more detail below, the first server computer 102, in addition to providing the requested content from a page or database in a reply 110, the reply also includes additional data, herein called a “cookie”, which is stored on the client computer. In this implementation, one or more cookies, as described in more detail below, provides a hierarchical description of the pages, queries and database records accessed on the first server computer by the client computer.

This additional data, or cookie, that is stored on the client computer can be used for several purposes. One purpose, as described in more detail below, is to redirect a user of the client computer 106 back to content provided by the first server computer 102 when accessing a second website of a second server computer 112. This redirection is also called retargeting.

Retargeting can occur, for example, when a second server computer 112 serves a page of a second website containing, for example, recommended content linked to the first website, in replies 114 to requests 116 from the client computer 106. The webpage in the reply 114 can include additional data indicative of this other recommended content. For example, the webpage may incorporate a computer program, typically in the form of a script that, when processed by the client computer, presents the webpage and causes the client computer to access additional content from yet another computer to present as part of the webpage.

In FIG. 1, the other computer is illustrated as a content server 120 which receives a content request 122. The content request 122 originates from the client computer 106 as a result of the client computer executing a computer program as part of the web page served by the second server computer 112. The content request can include data from one or more cookies stored on the client computer. In response to the content request 122, the content server 120 provides recommended content 124 that corresponds to the content request 122. How the content server 120 can generate the recommended content related to the first website on the first server computer is described in more detail below. As shown in FIG. 1, the content server can use the data from the content request 122 to select content data 130 that matches cookie data from the content request 122. Such content data generally is provided by individuals responsible for the first server computer. While FIG. 1 shows this content data 130 originating from the first server computer, it may be provided through many different channels. The recommended content 124 can then be provided to the client computer 106 for integration within the webpage being viewed from the second server computer.

It should be understood, however, that a content server 120 does not always select the recommended content related to the first website. For example, if the content server is implemented using an advertisement server, such a server generally has an algorithm that selects an advertisement to present based on numerous factors, and the selected advertisement in any given instance may be selected from a large number of possible sources. As described herein it should be understood that the presentation of recommended content related to the first website in a particular instance assumes that the content server has selected the first website as the source of the recommended content in that instance.

To implement retargeting, the recommended content 124 includes one or more links to content or a resource on the first server computer. As described in more detail below, such links can be adapted to the hierarchical information in the cookie stored on the client computer. When the recommended content 124 is displayed on a client computer in the context of a webpage from the second server computer, manipulation of the recommended content, such as by a “click” or “tap” gesture from the user with respect to the recommended content, causes the client computer to invoke the link in the recommended content. Invoking the link directs the client computer to issue a request 108 to the first client computer for the resource specified in the link.

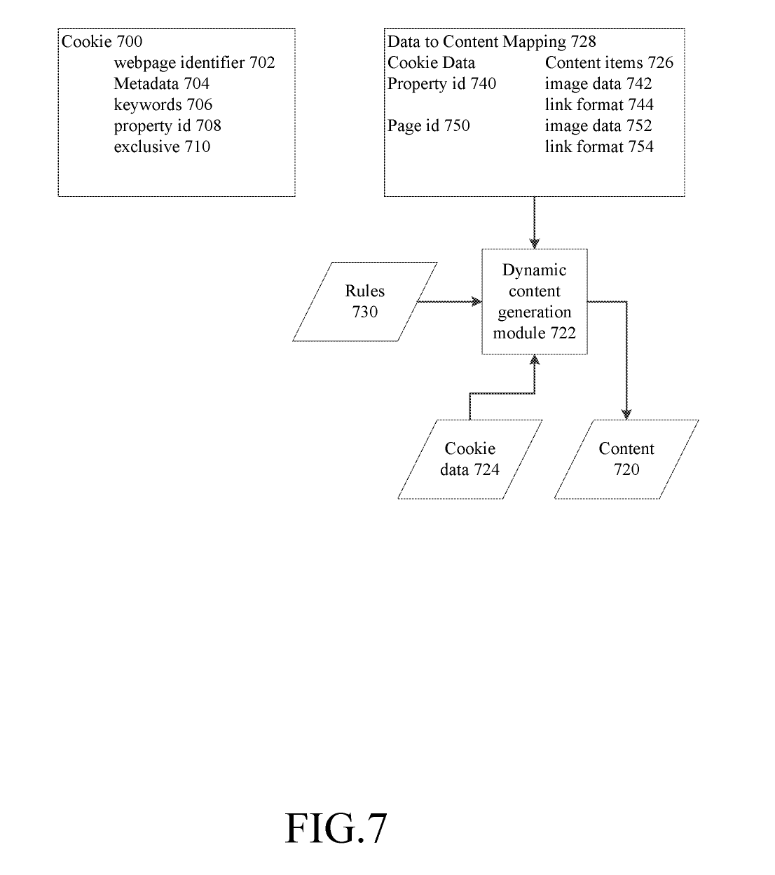

The first server computer, client computer, second server computer and content server each can be implemented using a general purpose computer, such as described below in connection with FIG. 7. Such computers are configured, for the server computers and content server, by computer programs that implement a web server, and connection of the web server to any related database. There are a variety of commercially available computer programs for implementing a web server, content server and database that can be modified so as to incorporate the functionality as described herein. Such computers are configured, for the client computer, by computer programs the implement a web browser, of which there are a variety that are commercially available. Client computers can be in a variety of forms, including but not limited to personal computers, laptop computers, mobile phones, tablet computer, other handheld computers, and the like. It should be understood that FIG. 1 is merely illustrative in that there may be many server computers, client computer and content server computers.

The recommended content 124 is related to the content accessed from the first server computer, which can be served when the client computer accesses the appropriately configured second server computer from that client computer. Recommended content can include, for example, an image related to the originally accessed content, or dynamic content derived from metadata associated with the accessed content, or other content depending on the data stored on the client computer. The metadata can be used, for example, to construct a search query to a database on the first website. If the user selects the recommended content from the second website, a search can be performed on the database on the first website which in turn returns results from that database.

As a particular example of such retargeting, the originally accessed content from a first website can be, for example, search results from a real estate database, a particular real estate offering from the real estate database, a particular real estate offering from a particular broker (which may be called an “exclusive” listing), or yet other content from a real estate broker website such as a home page, a broker page, or a location or city page providing information about properties in a specific location. The recommended content placed in the second website can be, for example, an offer to redirect the user to the first website, such as to direct the user to the originally accessed content, or perform a search for real estate from that real estate database. The recommended content in this instance can include a link to the resource to be accessed on the first website, and an image of a particular real estate offering that was previously view or other generic image of real estate such as a stock photo, and can include dynamically generated text indicating the parameters of a search to be performed. The parameters of the search can be extracted from metadata associated with the particular real estate offering which was previously viewed, which may be stored in a cookie. For example, if the previously viewed offering was a three-bedroom, single-family home in a particular city or region, then the search can be for three-bedroom, single-family homes in the same city or region.

As a particular example, a user accesses a real estate website and views a web page describing a particular property. A cookie is stored indicating that property was accessed. At another time, the user accesses another web page, which is configured to serve recommended content through the content server. The content server has access to information indicating that the user accessed a web page describing a particular property from the cookie. The content server then serves recommended content on the currently viewed web page. The recommended content includes an image for the originally viewed property, and dynamic content derived from information about that property, such as “Would you like to search for [#] bedroom [housing types] in [city, state] or [zip code]”, where the “#”, “housing type” (e.g., single-family homes, condominium, apartment, etc.), “city, state” and “zip code” values are metadata extracted from the information about the originally viewed property from the real estate database. If the user selects the recommended content in the currently viewed web page, the user is redirected to the real estate database website, and a query based on the recommended content is performed on that real estate database.

Having now described the general operating environment for such a system, more details of an example implementation of the hierarchical cookies and retargeting using them will now be provided in the context of an example application using a real estate related website that allows searching of a real estate database for properties.

In this example implementation, a real estate database includes a plurality of properties. A property can have a variety of information associated with it that can be stored in the database. For example a record 200 for a property can include information such as a property identifier 202, a property type 204, a number of bedrooms 208, a number of bathrooms 208, a zip code 210, a price 212, a reference to one or more pictures 214 and other information 216. Examples of such other information include, but are not limited to, a street address, a keyword or text description of a property, a geographic area, such as a city or county or neighborhood, or other characteristics of a property such as a number of rooms, floors, units, acres of land.

Another kind of data stored in this system is the cookies stored on the client computer. An example structure of a cookie is shown at 220. A cookie 220 can store a variety of information from a website. Generally speaking, a cookie includes information about a page accessed by the client computer on a website. This information generally includes an identifier 222 of the server computer serving the website, such as the domain name or other identifier. The cookie also can include an identifier 224 that is related to the client computer or user of the client computer. A variety of other information 226 can be stored in the cookie. The format and content of the cookie generally depends on the computer program code used to generate the cookie. In many cases, the computer program code for generating a cookie is supplied by an entity that is running the content server, as the cookie generally needs to be in a format that can be processed by the content server. This computer program code may allow the designer of the website to provide data to be stored in a cookie.

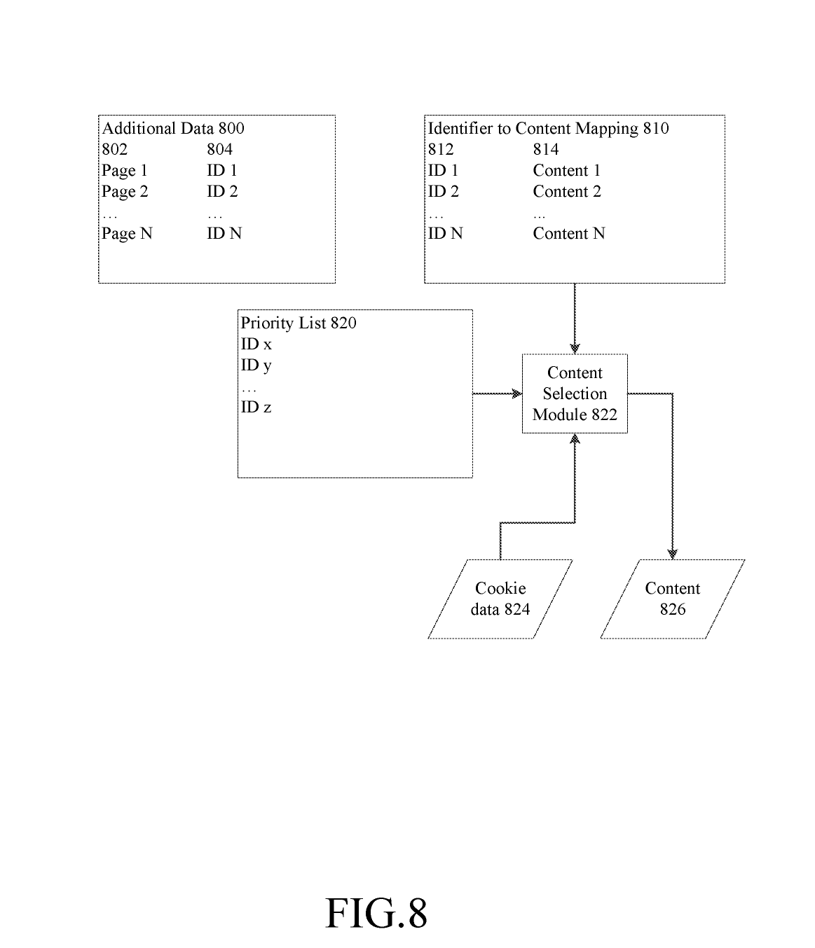

In the examples described in more detail below in connection with FIGS. 7 and 8, the cookies can store any other information as instructed by the computer program code of the webpage that generates and stores the cookie. For example, different pages of a website can store different identifiers in a cookie or in multiple different cookies. In connection with a real estate website, the cookie can include other information. For example, a cookie can include a property identifier, indicating a specific property last accessed by the client computer from the first server computer. As another example, a cookie can include metadata about a property. Similarly, a cookie can store search terms used to access the real estate database. A cookie can store indications of different pages of the first website that have been accessed. An indication of records accessed after a search also can be stored.

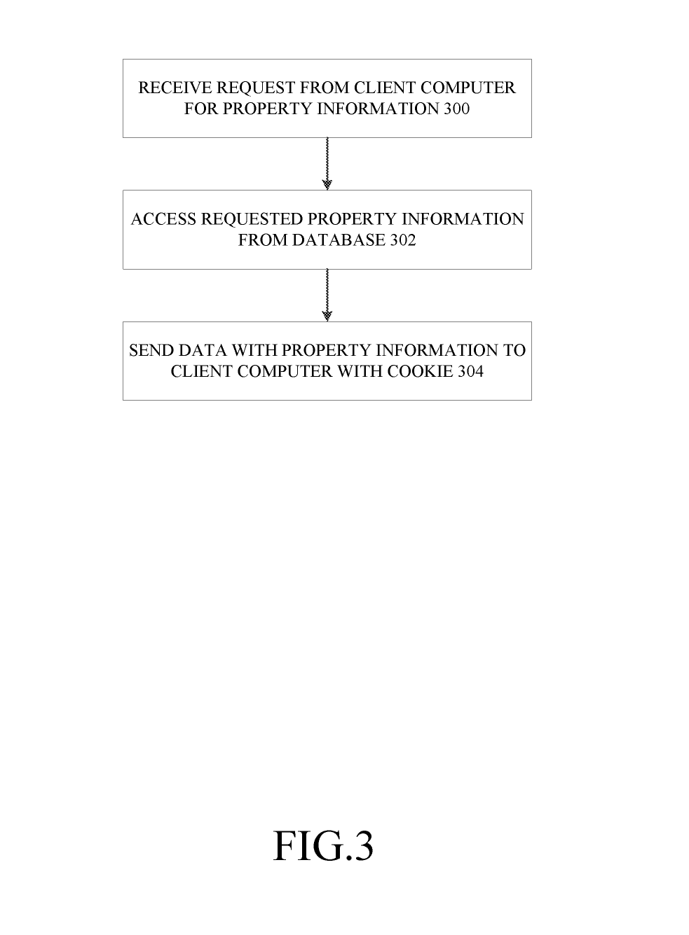

Turning now to FIG. 3, a flow chart of an example operation of the first server computer will now be described. This flow chart assumes that the client computer has already received search results from a query on the real estate database. In operation, a first server computer receives 300 a request from the client computer for property information. The first server computer accesses 302 the requested property information from the database. The first server computer constructs a webpage for processing by the client computer to display the requested property information. The data with the property information is sent 304 to the client computer, with code that stores at the client computer, in the cookie for the first server computer, information about the requested property.

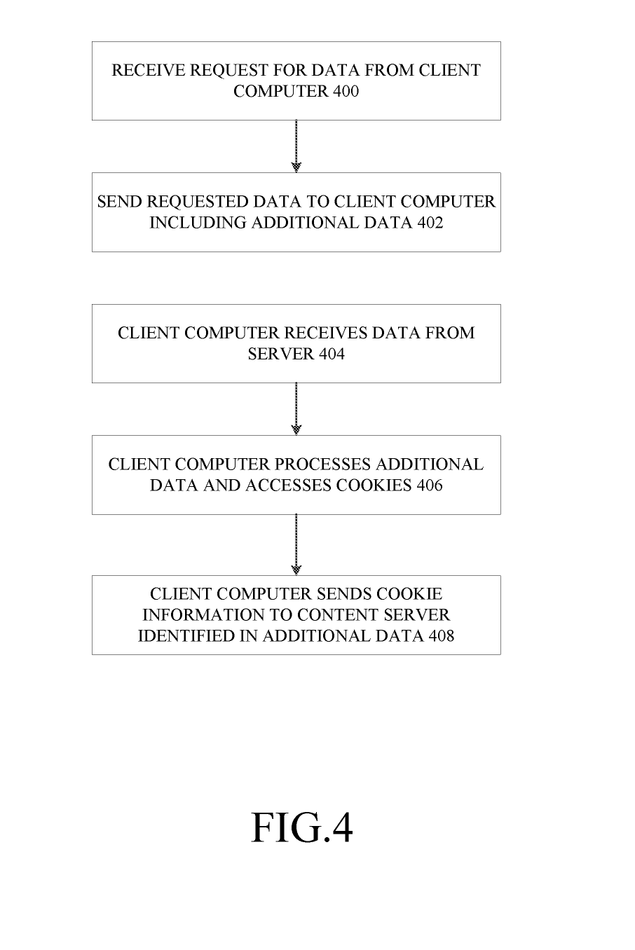

Turning now to FIG. 4, an example of operation of the system, and the interaction of the client computer and a second server computer and the content server computer, will now be described.

After a user accesses the first website, it is likely the user will access other websites. To do so, the client computer is instructed to access, for example, the second server computer. The second server computer receives 400 a request for data from the client computer. The second server computer then sends 402 the requested data in a web page that includes additional data used to generate the additional recommended content, which may be, for example, an advertisement that links to the website of the first server computer. Specifically, the additional data includes one or more computer programs, such as a script, that, when executed by the client computer as part of processing the requested web page, instructs the client computer how to obtain the recommended content, e.g., advertisement. For example the script may identify which cookie data to access on the client computer and which content server to contact.

The client computer then receives 404 the data from the second server computer. The client computer processes 406 the additional data, e.g., executes the script, and accesses the cookies. As a result of processing the additional data, the client computer sends 408 cookie information to the content server identified in the additional data.

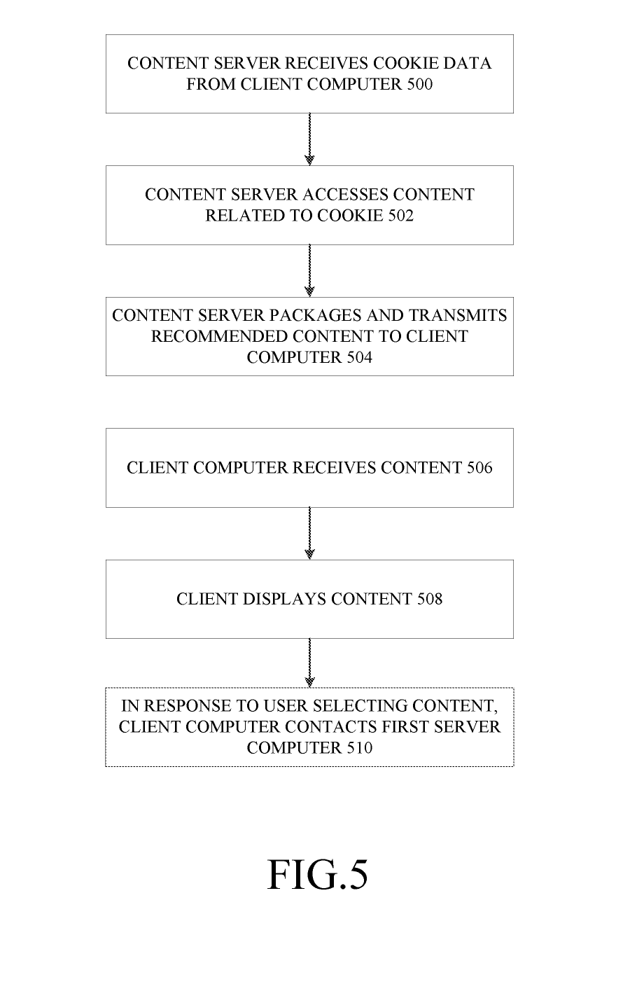

Referring now to FIG. 5, the content server receives 500 the cookie data from the client computer. The received data may indicate a resource at the content server to be used to generate the recommended content, e.g., an advertisement, based on the cookie. Using the cookie data, the content server then accesses 502 recommended content. The content server packages 504 the recommended content and transmits the recommended content to the client computer. The recommended content that is accessed depends in part on the algorithm used to select a source to be used for the recommended content. For example, when the content server is an advertisement server, the advertisement server selects an advertiser from which an advertisement is served and generates an advertisement based on the selected advertiser. In the event the content server selects the first website as a source of the recommended content, then recommended content provided from the first website to the content server is then used, in combination with the cookie data from the first website, to generate the recommended content.

Generally speaking, the recommended content provided from the first website is designed to correspond to possible cookie data from the first website that can be stored on a client computer. More details of two example implementations of cookie data and corresponding content data are provided in FIGS. 7 and 8 below. As an illustrative example, if the cookie data includes a property identifier, then the content server can use the property identifier to access and generate corresponding recommended content, such as an image and other data, related to that property as provided from the first website. As an example, the recommended content can include an image of the last requested property overlaid with a database query that, when invoked on the client computer, causes the client computer to issue a query to the real estate database for properties similar to this last viewed property.

After receiving 506 the recommended content from the content server, the client computer displays the recommended content 508 in the context of the webpage from the second server computer. When the webpage is displayed with the recommended content, the user can manipulate the recommended content. Assuming the recommended content relates to the first website, manipulating the recommended content causes the client computer to request 510 content from the first server computer as specified by a link associated with the recommended content as displayed in the webpage from the second server computer.

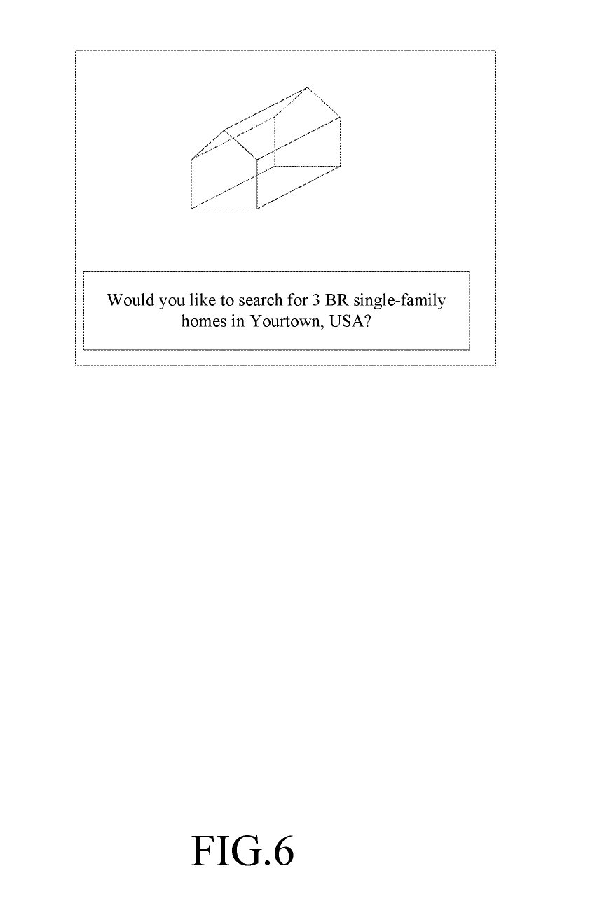

Referring now to FIG. 6, an example of the recommended content, as an offer to redirect the user to access the real estate database, the recommended content can include an image of a property, such as a last property viewed, and text, associated with a hyperlink. The text can be user readable and suggest that the user may wish to search for properties of a similar type (e.g., three-bedroom single family homes) in the same location (e.g., Yourtown, USA), with a link that includes a request to access the real estate database of the first server computer, and perform a search on the database with such search terms.

Such retargeting is implemented in a way that any recommended content are progressively more specific in relation to how progressively more engaged a user has been with a website. For example, recommended content for a user who has accessed a specific record from a database on a website can be more specific than recommended content for a user who has accessed only a “home” page or other higher level page on that website. To provide such an implementation, the additional data stored on the client computer, e.g., the one or more “cookies”, are progressively more detailed as the user is more engaged, and the corresponding recommended content served by the content server is progressively more specific.

To provide this relationship between the stored additional data and the corresponding recommended content, there can be several implementations. Referring now to FIGS. 7 and 8, two example implementations will now be described in more detail.

Referring now to FIG. 7, an example implementation, in which recommended content is dynamically generated, will now be described. In this implementation, the additional data stored in a cookie, as illustrated at 700, can include a variety of possible information, depending on how engaged a user is with a website. As the user becomes more engaged, additional webpages will cause additional information to be stored. In the example cookie 700, information that can be stored in a cookie can include an identifier 702 of a page or resource that has been accessed. Metadata about a record in a database also can be stored, as indicated at 704. Such metadata can include, for example, for a real estate item, values from fields from the record such as a number of bedrooms, bathroom, city, or values derived from such fields, such as a price range. Similarly, keywords 706 used in a search to access a database can be stored. As another example, a specific property identifier 708 can be stored. Whether the property is “exclusive” to a particular broker also can be stored 710.

Corresponding to this data is recommended content to be accessed by a content server. The content server, in this instance, is capable of dynamically generating recommended content 720, using a dynamic content generation module 722, which receives as an input the cookie data 724 and accesses content items 726. The content items can be stored in a form of mapping 728 that maps data (of the type that can be stored in a cookie) to the content items 726. The combination of content items using cookie data may be specified by one or more rules 730.

In the example shown in FIG. 7, an example mapping 728 can include relationships such as: a property identifier 740 being mapped to an image 742 and a link format 744; a page identifier 750 being mapped to an image 752 and a link format 754. Rule 730 can include rules such as: code that combines a link format and metadata to create a link to search the database; code that checks whether a property is “exclusive” and delivers an image of the actual property if the property is exclusive and otherwise serves a generic image. In such an example, the metadata about a property and an identification of a particular property for which there is an image can be used to dynamically generate recommended content that includes the image for the originally viewed property, and a phrase such as “Would you like to search for [#] bedroom [housing types] in [city, state] or [zip code]”, where the “#”, “housing type” (e.g., single-family homes, condominium, apartment, etc.), “city, state” and “zip code” values are from the metadata.

Referring now to FIG. 8, an example implementation, in which recommended content is statically generated, will now be described. In this implementation, the additional data stored in a cookie, as illustrated at 800, can include one or more cookies that store one or more identifiers selected from a set of available identifiers associated with the website. In order to provide different cookies that indicate how engaged a user is with a website, different pages or other resources are associated with different identifiers. For example, each resource, including, for example, each record in a database, can be associated with an identifier unique to that resource. It is possible to have some pages share an identifier; it is possible for a page not to have any identifier or cookie. As the user becomes more engaged, additional webpages will cause additional cookies to be stored. After engagement with a website, the client computer may have multiple different cookies from the website. This arrangement is illustrated in FIG. 8 by the additional information 800 including a mapping of multiple pages or resources (Page 1, . . . , Page N), with each page or resource 802 having a corresponding identifier (ID 1, . . . , IDN) 804.

Corresponding to this data is recommended content to be accessed by a content server. The content server, in this instance, receives cookie data that provides one or more identifiers of one or more pages. For each identifier, the content server has corresponding recommended content. In essence an identifier-to-content map 810 maps each identifier 812 to a file 814 or other data structure that provides the image and other data, such as the corresponding link, for the corresponding recommended content. The content server also receives a priority list 820. The priority list provides data indicative of how identifiers should be prioritized in the event that multiple identifiers from a website are available to the content server. The priority list, in this implementation, indicates the relative priority of identifiers such that the progressive engagement of the user with the website has been reflected.

In this implementation, a content selection module 822 receives the cookie data 824 for a first website (assuming that the first website has been selected as the source for the recommended content), and provides the corresponding recommended content 826, based on the identifiers in the cookie data 824, the priority list 820 and the identifier to content mapping 810.

In a particular example with respect to real estate, an identifier related to a home page of a website has lowest priority; an identifier related to an exclusive listing of a broker owning the website has the highest priority. An identifier of a page of properties from a specific location, or for a page for a broker, or for a particular property, for example, can have an intermediate priority.

The recommended content in this example is statically generated. Thus, to create recommended content of the form of an image for a viewed property, and a phrase such as “Would you like to search for [#] bedroom [housing types] in [city, state] or [zip code]”, such recommended content is statically generated and associated with the identifier provided for the resource used to access that property.

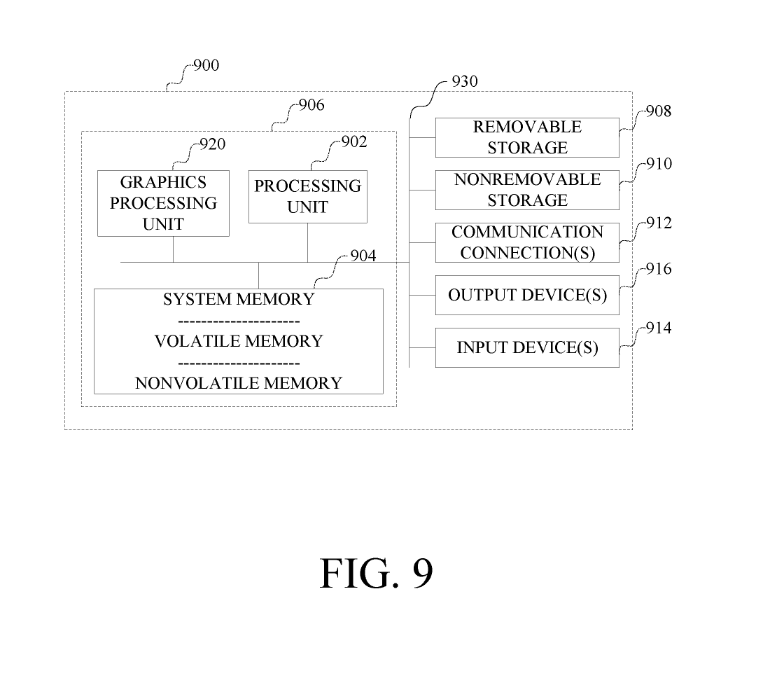

The various computers used in this computer system can be implemented using one or more general purpose computers, such as client computers, server computers and database computers, which can be programmed to implement the functionality such as described in the foregoing example implementations. FIG. 9 is a block diagram of a general purpose computer with computer programs providing instructions to be executed by a processor in the general purpose computer. Computer programs on a general purpose computer generally include an operating system and applications. The operating system is a computer program running on the computer that manages access to various resources of the computer by the applications and the operating system. The various resources generally include memory, storage, communication interfaces, input devices and output devices.

Examples of such general purpose computers include, but are not limited to, larger computer systems such as server computers, database computers, desktop computers, laptop and notebook computers, as well as mobile or handheld computing devices, such as a tablet computer, hand held computer, smart phone, media player, personal data assistant, audio and/or video recorder, or wearable computing device.

With reference to FIG. 9, an example computer 900 includes at least one processing unit 902 and memory 904. The computer can have multiple processing units 902 and multiple devices implementing the memory 904. A processing unit 902 can include one or more processing cores (not shown) that operate independently of each other. Additional co-processing units, such as graphics processing unit 920, also can be present in the computer. The memory 904 may include volatile devices (such as dynamic random access memory (DRAM) or other random access memory device), and non-volatile devices (such as a read-only memory, flash memory, and the like) or some combination of the two, and optionally including any memory available in a processing device. Other memory such as dedicated memory or registers also can reside in a processing unit. This configuration of memory is illustrated in FIG. 9 by dashed line 906. The computer 900 may include additional storage (removable and/or non-removable) including, but not limited to, magnetically-recorded or optically-recorded disks or tape. Such additional storage is illustrated in FIG. 9 by removable storage 908 and non-removable storage 910. The various components in FIG. 9 are generally interconnected by an interconnection mechanism, such as one or more buses 930.

A computer storage medium is any medium in which data can be stored in and retrieved from addressable physical storage locations by the computer. Computer storage media includes volatile and nonvolatile memory devices, and removable and non-removable storage media. Memory 904 and 906, removable storage 908 and non-removable storage 910 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 900 may also include communications connection(s) 912 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 912 are devices, such as a network interface or radio transmitter, that interface with the communication media to transmit data over and receive data from signals propagated through communication media.

The communications connections can include one or more radio transmitters for telephonic communications over cellular telephone networks, and/or a wireless communication interface for wireless connection to a computer network. For example, a cellular connection, a WiFi connection, a Bluetooth connection, and other connections may be present in the computer. Such connections support communication with other devices, such as to support voice or data communications.

The computer 900 may have various input device(s) 914 such as a various pointer (whether single pointer or multipointer) devices, such as a mouse, tablet and pen, touchpad and other touch-based input devices, stylus, image input devices, such as still and motion cameras, audio input devices, such as a microphone. The compute may have various output device(s) 916 such as a display, speakers, printers, and so on, also may be included. All of these devices are well known in the art and need not be discussed at length here.

The various storage 910, communication connections 912, output devices 916 and input devices 914 can be integrated within a housing of the computer, or can be connected through various input/output interface devices on the computer, in which case the reference numbers 910, 912, 914 and 916 can indicate either the interface for connection to a device or the device itself as the case may be.

An operating system of the computer typically includes computer programs, commonly called drivers, which manage access to the various storage 910, communication connections 912, output devices 916 and input devices 914. Such access generally includes managing inputs from and outputs to these devices. In the case of communication connections, the operating system also may include one or more computer programs for implementing communication protocols used to communicate information between computers and devices through the communication connections 912.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

Each component (which also may be called a “module” or “engine” or the like), of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures. A data structure is defined in a computer program and specifies how data is organized in storage, such as in a memory device or a storage device, so that the data can accessed, manipulated and stored.

It should be understood that the subject matter defined in the appended claims is not necessarily limited to the specific implementations described above. The specific implementations described above are disclosed as examples only.

What is claimed is:

1. A computer system, comprising:
a first server computer configured to provide access by client computers to a database, wherein the first server computer is configured, in response to a request from a client computer, to:
receive a query on the database;
generate content responsive to the query from the database;
provide the content to the client computer in a webpage and additional data indicating information about the access of the database;
the client computer being configured to:
receive the webpage from the first server computer; and
process the webpage, such that in response to processing the webpage, the additional data is stored on the client computer;
the client computer being further configured, in response to receiving data from a second server computer including data for accessing recommended content, to:
process the data for accessing recommended content to request recommended content from a content server specified by the data and using the additional data from the first server computer stored on the client computer; and
present the recommended content received from the content server in response to the request, the recommended content including data for accessing the database through the first server computer.
